(19) United States
(12) Patent Application Publication
(10) Pub. No.: US 2025/0071249 A1
(43) Pub. Date: Feb. 27, 2025

(54) 3D STEREOSCOPIC SMARTPHONE

(71) Applicant: Ismael ROSAN, São Paulo (BR)

(72) Inventor: Ismael ROSAN, São Paulo (BR)

(21) Appl. No.: 18/721,681

(22) PCT Filed: Jul. 31, 2022
(86) PCT No.: PCT/BR2022/050299

§ 371 Date: Jun. 19, 2024

(30) Foreign Application Priority Data
Dec. 27, 2021 (BR) BR2020210265294

(51) Int. Cl. H04N 13/239; H04M 1/72403

(52) U.S. Cl. CPC H04N 13/239; H04M 1/72403; H04M 2250/52

(57) ABSTRACT

This is a product aimed mainly at the entertainment area, characterized by being a smartphone device that, in addition to the functions normally found in this type of device, also has the ability to produce stereoscopic photographic images or stereoscopic films, through a system of at least one camera attached to it, which has one or more pairs of optical lenses equipped with an image sensor for each lens, where each pair will work simultaneously, producing two instantaneous images of the same objective, with a small difference in framing and whose images, joined side by side, form a single photographic image or film frame. The images or film frames produced can then be viewed on the smartphone screen with the aid of a stereoscope or 3D glasses, obtaining an effect of three-dimensionality or depth in them, simulating human binocular vision, in a process known as stereoscopy.

### FIELD OF INVENTION

The present utility model is mainly aimed at the entertainment area, in particular for the production of photos and videos, however this does not prevent it from being used in the production of photos and videos in the professional field.

### STATE OF THE ART

Stereoscopy has existed since the middle of the 19th century. It is a technique used to simulate the natural phenomenon that occurs in the binocular vision of humans and many animals, where through two points of vision, a three-dimensional image is produced with notion in depth.

A wide range of photographic cameras equipped with two optical lenses with the aim of reproducing this effect have been launched on the market since then. However, with the advent of smartphone-type cell phones, which can currently produce photos and films with very high resolution, this type of camera has fallen into disuse, being mostly restricted to the professional field and even so, with acquisition prices that are sometimes high where As an example, we have the very current Intel Realsense Depth Camera D435 camera and camcorder.

### Problem to be Solved

This stereoscopy technique, obtained with cameras intended for this purpose, has not migrated to the smartphone market. To date, there is no knowledge of any device with these characteristics. What existed similarly were unsuccessful attempts to obtain a single image from photos and videos in 3D, without using a stereoscope or 3D glasses. For example, we had the launch in 2011 of the HTC Evo 3D and LG Optimus 3D and 3D Max smartphones, but with disappointing results, failing to make an impact on the consumer market.

Most smartphone device manufacturers still pursue the objective of achieving perfect three-dimensionality in a single image, but nothing relevant to date has been produced or published. And if they do, the value of the product will probably be beyond the reach of the average person.

In this way, there is still a huge audience made up of people who have never heard of stereoscopy, a stereoscopic camera, nor the possibility of photographing and filming their loved ones, for example, in order to obtain a perfect 3D view of them., with the clear feeling of seeing them live, even with the use of 3D glasses.

For those who are aware of this technique or the virtual reality resource as it is currently called, the only option left is to watch ready-made videos that exist in profusion on the market, but who would certainly want to create their own videos or 3D photos.

Therefore, we still have a huge market that is unaware of this technique, or if they do know it, they have no way of implementing it in a practical, easy and cheap way. And it is exactly for this large audience that this utility model is aimed.

### DESCRIPTION OF THE DRAWINGS

FIG. 1 shows the front view of the 3D stereoscopic smartphone cell phone showing the pairs of lenses (2) (3) to be used alternately to obtain instantaneous frontal stereoscopic images commonly called “selfies”.

FIG. 2 shows the rear view of the 3D stereoscopic smartphone cell phone showing the pairs of lenses (7) (8) to be used alternately to obtain subsequent stereoscopic instant images.

FIG. 3 shows the front view of the 3D stereoscopic smartphone cell phone with the two instantaneous images generated, joined into just one, ready to be viewed with the aid of a stereoscope or 3D glasses, with a three-dimensional effect.

FIG. 4 shows the view with the 3D stereoscopic smartphone cell phone with the two instantaneous images generated and joined into just one, being positioned on the stereoscope or 3D glasses.

FIG. 5 shows a presentation of the 3D stereoscopic smartphone, already properly inserted into the stereoscope or 3D glasses, being viewed by a young user and enjoying the effects of three-dimensionality.

FIG. 6 shows a 3D stereoscope used in the past.

FIG. 7 shows a current 3D stereoscope.

FIG. 8 shows a 3D stereoscope made from cardboard and plastic lenses.

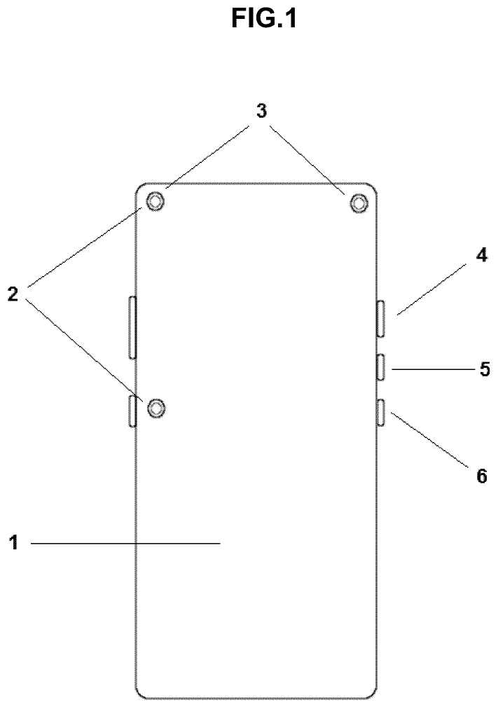

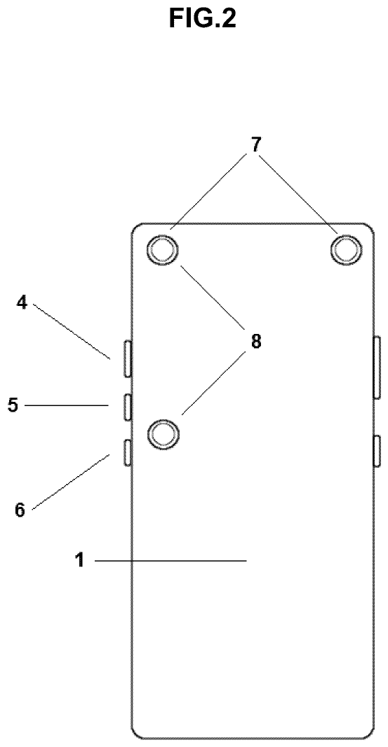

### FUNDAMENTALS OF THE INVENTION

This patent application for the invention of a utility model refers to a smartphone-type cellular device, which in addition to the functions normally present in this type of device, also has the ability to produce stereoscopic photos and videos that can be viewed with three-dimensional or depth effect, through the use of 3D glasses or stereoscope. To this end, it has a system with at least one camera attached, equipped with at least one pair of optical lenses, arranged at an ideal distance of 6.35 cm, simulating the average distance of human eyes and which will produce instantaneous and simultaneous images of the same objective with a small difference in framing and which will be joined side by side, forming a single photographic image or film frame.

The images or film frames produced can then be subsequently viewed on the device screen with the aid of a stereoscope or 3D glasses, obtaining an effect of three-dimensionality or depth in them, simulating human binocular vision, in a process known as stereoscopy.

### DESCRIPTION OF THE INVENTION

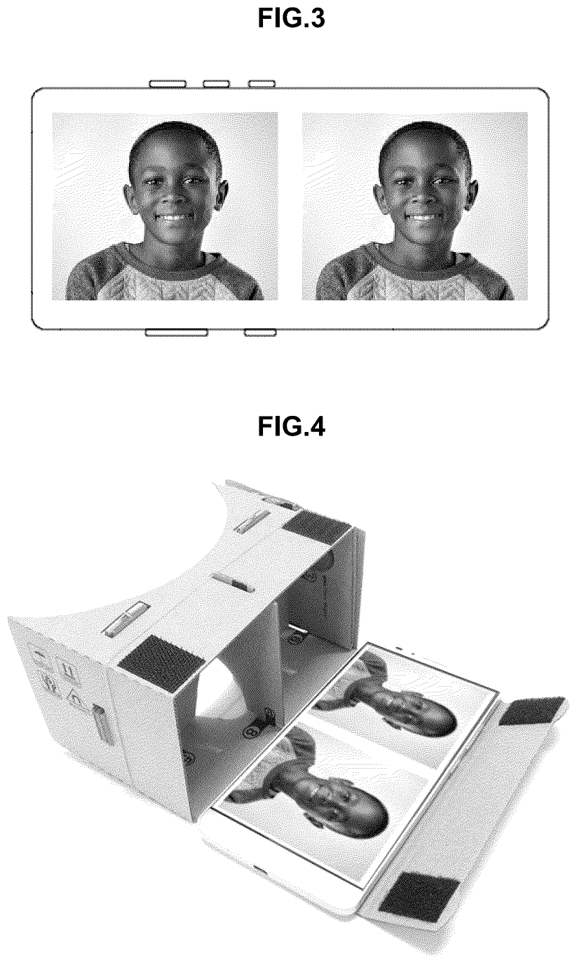

The present utility model (1), has, in addition to the normal functions of a smartphone-type cellular device, one or more cameras equipped with one or more pairs of optical lenses fixed to the anterior external portion of the device (2) (3) and one or more pairs of optical lenses fixed to the rear external portion of the device (7) (8) and which are equipped with an image sensor in each of them, allowing the camera to have the capacity to produce two instantaneous images of the same objective, with a small difference in framing and which will be joined side by side, forming a single photographic image or film frame, as shown in FIG. 3.

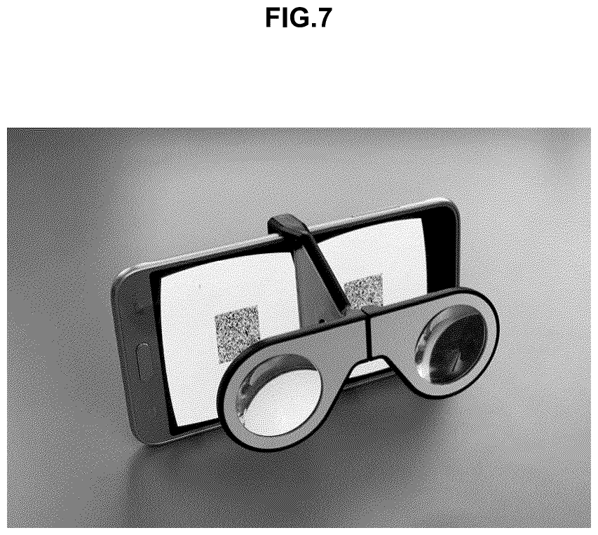

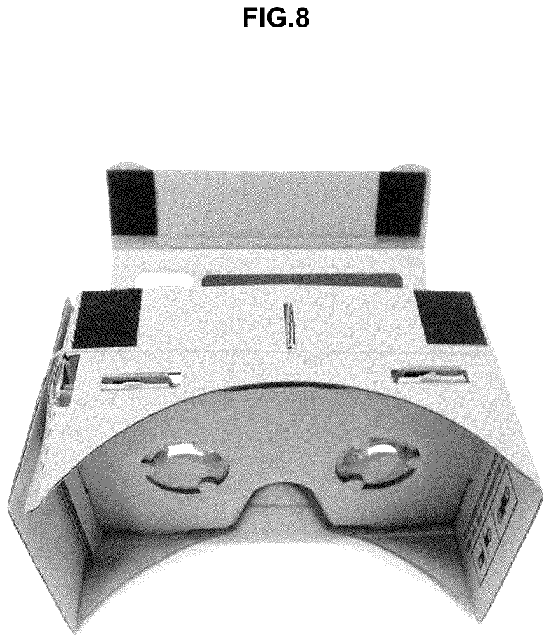

The images or film frames produced can then be subsequently viewed on the device screen (1) with the aid of a stereoscope or 3D glasses as shown in FIGS. 7, FIG. 8 and FIG. 9, obtaining an effect of three-dimensionality or depth in them, simulating human binocular vision, in a process known as stereoscopy.

The types of images to be produced will depend on the user's choice, through a button on the screen or on the side of the device (5), which presents the 2D or 3D options, being 2D for a single image and 3D for two instantaneous images of the same objective that will be joined side by side, forming a single image or film frame, which can be viewed later with the aid of a stereoscope or 3D glasses as shown in FIG. 4, obtaining a three-dimensional effect.

Once the type of image has been chosen, simply choose from then on whether the object to be photographed or filmed will be in front of or behind the device's camera (1), via a button on the screen or on the side of the device (6).

It is then necessary to choose whether the operation will be a photo or a video, through the appropriate choice, on the device screen (1).

If the device (1) has more than one pair of lenses, the device's internal system (1) will automatically select which lens for 2D photos or filming or pair of optical lenses for 3D photos or filming will be activated, the based on the selections made by the user and also by the positioning of the cell phone, whether horizontally or vertically.

For 3D photos or films with the objective positioned in front of the device (1), commonly called “selfies”, the system will activate for photos or films in portrait format, the pair of lenses (2), and for photos or films in landscape format the pair of lenses (3).

For 3D photos or films with the objective positioned on the back of the device (1), the system will activate the pair of lenses (7) for photos or films in portrait format and for photos or films in landscape format, the pair of lenses (8).

From then on, simply start the operation by pressing the appropriate key on the screen or on the side of the device (4).

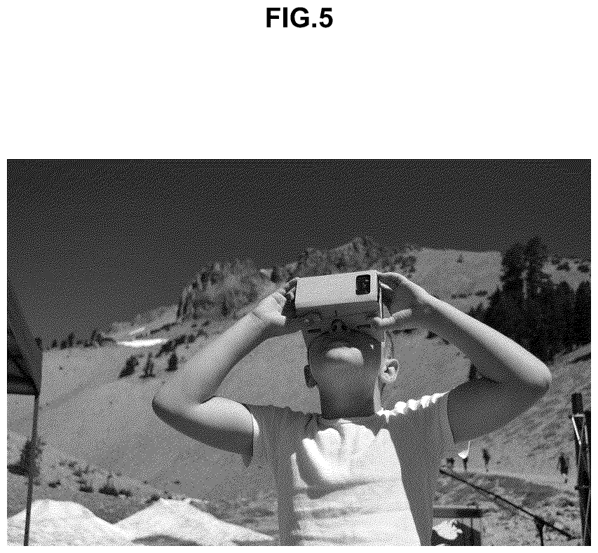

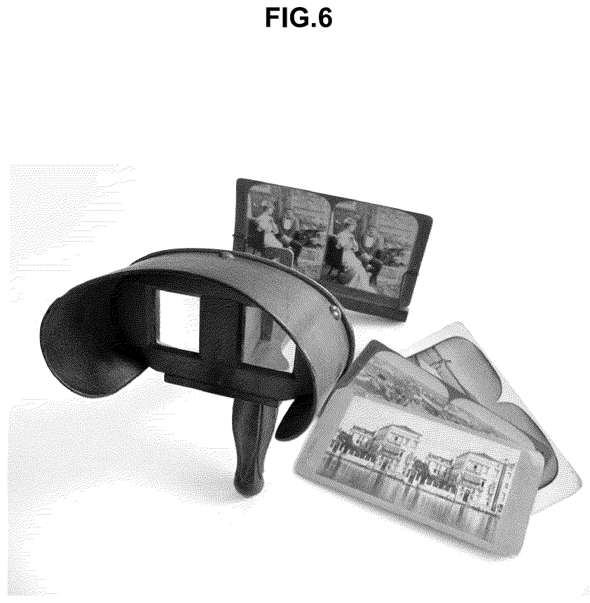

Once the operation is complete, to view the photos or videos in 3D, simply select the desired photo or video on the device screen (1), inserting the device (1) into the appropriate stereoscope or 3D glasses as shown in FIG. 4, then closing it and pressing the “play” key on the screen or on the side of the device (4) and enjoy the effects of three-dimensionality or depth of the images produced as shown in FIG. 5.

### Examples of Embodiments of the Invention

The present utility model (1) is a product that is very accessible to all social classes, as in its simplest conception, it is enough to have a camera attached with just two simple objectives on the back of the device and that works in synchronization, they will produce beautiful images and videos in 3D of the most varied situations, from a simple birthday party, to filming a car or bicycle ride, with the 3D stereoscopic smart phone (1), which is the utility model here proposed, fixed on the vehicle dashboard or fixed on the handlebars of a bicycle, recording the entire route taken, to later be viewed in its entirety, that is, with a notion of three-dimensionality or depth of the images produced, with the help of the 3d glasses.

There is currently no device with these characteristics currently on the market that is accessible to any economic class.

Smartphone cell phones should not be confused with this 3D filming feature, which does not currently exist and which is the proposal of this utility model (1), with smartphone cell phones with 360° photo or filming features normally available on the market., but they are not the same thing.

Therefore, due to the advantages of ease that this utility model offers and because it has truly innovative and surprising characteristics, the 3D STEREOSCOPIC SMARTPHONE CELL PHONE meets all the necessary conditions to deserve the utility model patent.

1. 3D STEREOSCOPIC SMARTPHONE-is a device (1) smartphone-type cell phone, consisting of: optical lenses on its front (2) (3) and back (7) (8), as well as an appropriate key on the screen or on the side of the device (4), button on the screen or on the side of the device (5) and button on the screen or on the side of the device (6), characterized by: having a camera attached to it (1), equipped with a pair of optical lenses equipped with of image sensors (2) and (3) attached to the front face of the device (1) and arranged at an ideal distance of 6.35 cm from each other, with the pairs of optical lenses or optical sensors (2) and (3) they are arranged at 90° to each other; and the pairs of optical lenses (or optical sensors) (7) and (8) that are coupled to the rear face of the device (1) and arranged at a distance from each other equivalent to human eyes, with the pairs of optical lenses or sensors optics (7) and (8) are arranged at 90° to each other.

2. 3D STEREOSCOPIC SMARTPHONE CELL PHONE-according to claim 1, characterized: by the fact that the distance between the optical lenses (2) (3) and (7) (8) may vary more or less, which may, however, compromise the final result obtained.

3. 3D STEREOSCOPIC SMARTPHONE CELL PHONE-according to claim 1, characterized: by the fact that there may be more pairs of optical lenses equipped with image sensors, on the front (2) (3) and back (7) (8) faces of the device (1).

4. 3D STEREOSCOPIC SMARTPHONE CELL PHONE-according to claim 1, characterized by: native software on the device, which will instantly and simultaneously capture two images of the same objective through one of the pairs of lenses on the device (1), according to the user's choice: for photos or filming commonly called “selfies”, with the objective positioned on the front part of the device (1), in portrait format, the pair of lenses (2) and in landscape format, the pair of lenses (3); for photos or films with the objective positioned on the back of the device (1), the pair of lenses (7) will be activated for photos or films in portrait format and the pair of lenses (8) for photos or films in landscape format;
the images produced by each optical lens or image sensor, will be mounted side by side horizontally at an ideal distance of 6.35 cm between their centers and where a single stereoscopic photographic image or a single frame of stereoscopic film will be formed, so that when the image is captured by pairs of lenses (7) and (8), the image captured by the left optical lens or image sensor is positioned on the left side of the final image and the image captured by the right optical lens or image sensor be positioned on the right side of the final image; and when the image is captured by pairs of lenses (1) and (2), the treatment must be inverted, as it is a “selfie” image capture, that is, the image captured by the optical lens or sensor left image sensor is positioned on the right side of the final image and the image captured by the right optical lens or image sensor is positioned on the left side of the final image, and in the end they will remain recorded on the device or external media and can be viewed later on the device screen (1), with the aid of a stereoscope or 3D glasses, which are not part of the present invention, obtaining a three-dimensional or depth effect on them.
